(19) United States
(12) Patent Application Publication
(10) Pub. No.: US 2014/0332609 A1
(43) Pub. Date: Nov. 13, 2014

(54) Shower Nozzle Device

(71) Applicant: Ching-Ho LAI, Taichung City (TW)

(72) Inventor: Ching-Ho LAI, Taichung City (TW)

(21) Appl. No.: 13/960,518

(22) Filed: Aug. 6, 2013

(30) Foreign Application Priority Data
May 13, 2013 (TW) 102208887

(51) Int. Cl. B05B 15/06

(52) U.S. Cl. CPC B05B 15/065
USPC 239/589

(57) ABSTRACT

A shower nozzle device is disclosed. The sucking disc includes a gland and a pull rod. The shower nozzle device is assembled by passing a bolt at the same time through the holes formed on a pair of the protrusions on the back of the shower nozzle, the first through hole formed on a hollow cylinder extended from center of the gland and the second through hole formed on a rod body extended from center of the pull rod.

### BACKGROUND OF THE INVENTION

1. Field of the Invention

The present invention is related to a shower nozzle device, and more particularly related to a shower nozzle device configured to be attached on a flat surface.

2. Description of the Prior Art

A conventional household shower includes a shower nozzle connected to a water pipe, and the water pipe is installed at the outlet of the cold-hot water regulating device. The shower nozzle is installed at an altitude of an adult height and the shower nozzle can be inserted or hung on the fixture. However, this way is quite inconvenient. Because the shower nozzle kept stayed in the fixture, the region and the height where water sprays out are limited without being used extensively.

The shower nozzle is often used in the bathroom, in general, it is also used in a car-washing equipment. A lot of washing jobs can be done when a water pipeline connected to a faucet is disposed with the shower nozzle. However, during the washing process, it is quite inconvenient to have to put the shower nozzle on the ground first as a result of cannot holding kinds of washing tools at the same time, it will not be used until the work of foam-spraying and brushing done.

Based on the reason of the above, the present invention provides a shower nozzle device, which can be used on any flat surface, for example, such as a Wall, a glass surface or an adsorbed surface of any other materials. Therefore, when using the device in the shower, the shower nozzle device can be easily disposed on the wall or the flat surface before your eyes so that the shower area is enlarged, therefore, it is also suitable to the person which is not tall or disable. Moreover, the shower nozzle device attached to the wall can be easily detached from the wall or the flat surface. In addition, when applied for the car-washing, the shower nozzle device is able to have the sucking disc fixed in the flat surface, such as a car window or a car roof, which is more convenience to take steps of foam-spraying and brushing first.

### SUMMARY OF THE INVENTION

In order to solve the problems above, the main object of the present invention is to provide a shower nozzle device, which can be used on any flat surface, such as a wall, a glass surface or an adsorbed surface of any other materials. The shower nozzle device is composed of a sucking disc and a shower nozzle body. The sucking disc includes a gland and a pull rod. The shower nozzle device is assembled by passing a bolt at the same time through several holes, separately formed on the protrusion of the shower nozzle body, a hollow cylinder extended from the center of the gland and a rod body extended from the center of the pull rod.

Another object of the present invention is to provide a shower nozzle device. Moreover, the shower nozzle body includes a pair of the protrusions for assembling with the sucking disc and the bolt, located at the back of the shower nozzle body. The pair of the protrusions is a concave-shaped structure producing a space, by which two sides are separated. Each side has a hole that the bolt can pass through. The shower nozzle device is assembled by putting the hollow cylinder and the rod body into the space of the concave-shape structure, then the bolt is passed mutually through the first through hole on the hollow cylinder, the second through hole on the rod body and the holes at two sides of the concave-shape structure. The bolt is a strip-type cylinder to be the medium of the assembly to the shower nozzle body and the sucking disc.

One another object of the present invention is to provide a shower nozzle device. The gland includes the circular cover which the internal part is hollow to produce a space. A protrusion disposed in the radial direction of the circular cover is located in the internal surface between an open. end of the circular cover and an open end of the circular protrusion. The protrusion is a semicircular cylindrical shape and has a thickness L1 in the axial direction of the circular cover. The purpose of disposing the protrusion is to separate the gland and the pull rod when the user would like to detach the sucking disc from the adsorbed surface. The circular protrusion has a thickness L2 in the radial direction of the circular cover. The thickness L2 is in action to cause the plane of the pull rod to be against the open end of the circular protrusion when the gland and the pull rod are disposed together. In addition, as shown in FIG. 3, the plane of the pull rod includes a first adsorptive board and a second adsorptive board. The better configuration regarding to the rod body of the pull rod or the hollow cylinder of the circular cover prefers to be a hexagonal cylinder. The front side of the rod body has a second through hole to pass the bolt through so as to assemble the shower nozzle, the gland, the pull rod and the bolt together. The back side of the rod body is connected to the first adsorptive board and the second adsorptive board, and both discs are the same size and stacked each other. The second adsorptive board is used to be attached the adsorbed surface where the sucking disc is disposed. The material of the second adsorptive board is softer than the first absorbing board so as to be attached to the adsorbed surface easier.

One another object of the present invention is to provide a using method of the shower nozzle device, and attaching a shower nozzle device to the adsorbed surface or detaching it from the adsorbed surface. First, approaching the sucking disc to the adsorbed surface and turning the shower nozzle body to move backwards so that the plane of the sucking disc is able to be attached to the adsorbed surface;

and then moving the shower nozzle body forwards to turn the pair of the protrusions and pressuring the pair of the protrusions into the surface of the gland by the gravity of the shower nozzle body.

Secondly, the shower nozzle body is completely drooping and pressuring the pair of the protrusions into the surface of the gland by the gravity of the shower nozzle body. Based on the reason that the distance from the top pair of the protrusions outside to the hole is smaller than the distance from the bottom pair of the protrusions outside to the hole, the rotation of the pair of the protrusions can drive to move the pull rod and the plane forwards by pressuring the gland. Therefore, the air between the second adsorptive board and the adsorbed surface is excluded to enclose a vacuum and the first adsorptive board is firmly made against the open end of the circular protrusion to make the shower nozzle device attached firmly to the adsorbed surface. Thirdly, for the purpose of detaching the shower nozzle device from the adsorbed surface, turning the shower nozzle body and moving the shower nozzle body backwards to lift the shower nozzle body to form a gap between the protrusion within the gland and the plane of the pull rod. Thus, the vacuum is broken out when the air gets into the internal space of the gland, and that the distance from the top pair of the protrusions outside to the hole is smaller than the distance from the bottom pair of the protrusions outside to the hole, the rotation of the pair of the protrusions releases the pressure from the pair of the protrusions to the gland so as to drive the gland to move and to move the pull rod and the plane backwards.

One another object of the present invention is to provide another shower nozzle device. The shower nozzle device is composed of a shower nozzle body and a sucking disc. The shower nozzle body includes a pair of the protrusions disposed on a surface reversely opposite to blowholes (not shown) and each protrusion includes a hole. The sucking disc includes a gland and a pull rod, and the gland includes a circular cover and a hollow cylinder extended from the center of the circular cover. The hollow cylinder includes the first through hole. The pull rod includes a plane and a rod body extended from the center of the plane. The rod body is a hexagonal cylinder and has a second through hole in the front side of the rod body for passing the bolt through to assemble the shower nozzle, the gland, the pull rod and the bolt together. The back side of the rod body is connected to the plane, inclusive of the first adsorptive board and the second adsorptive board. Both discs are different sizes and the area of the second adsorptive board is larger than the first adsorptive board. The second adsorptive board is used to be attached to the adsorbed surface where the sucking disc is disposed. The material of the second adsorptive hoard is softer than the first adsorptive hoard so as to be attached to the adsorbed surface easier.

### BRIEF DESCRIPTION OF THE DRAWINGS

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, Serve to explain the principles of the invention.

FIG. 1A to FIG. 1D are respectively a 3D structural view illustrating the components of the shower nozzle device, according to the first embodiment of the present invention.

FIG. 2 is a 3D structural view illustrating the gland of the shower nozzle device, according to the first embodiment of the present invention.

FIG. 3 is a cross-sectional view illustrating the condition of the shower nozzle device attached to the adsorbed surface, according to the first embodiment of the present invention.

FIG. 4 is a cross-sectional view illustrating a condition before the shower nozzle device is detached from the absorbed surface shown in FIG. 3, according to the first embodiment of the present invention.

FIG. 5 is a cross-sectional view illustrating the process of the shower nozzle device attached to the adsorbed surface and detached from the adsorbed surface, according to the first embodiment of the present invention.

FIG. 6 is a cross-sectional view illustrating the shower nozzle device which the area of the second adsorptive board is larger than the first adsorptive board, according to the second embodiment of the present invention.

### DESCRIPTION OF THE PREFERRED EMBODIMENT

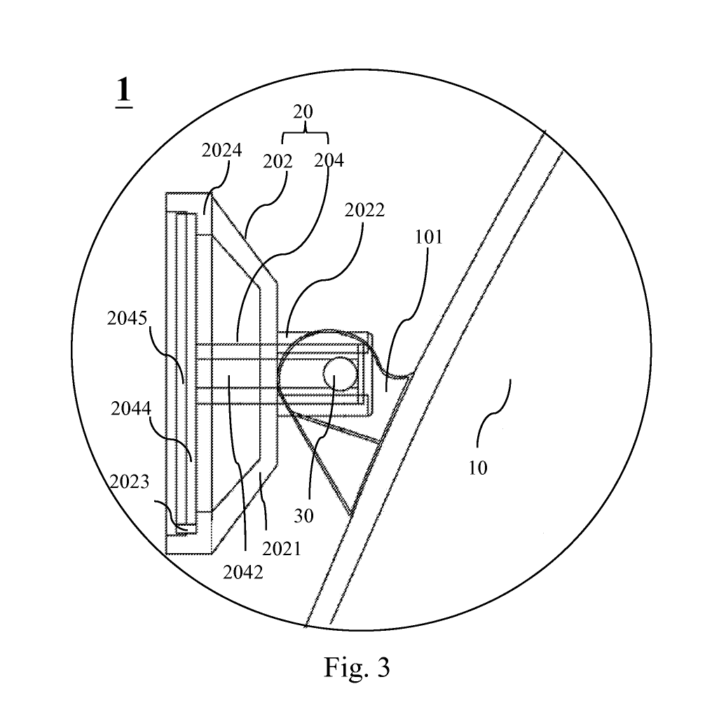

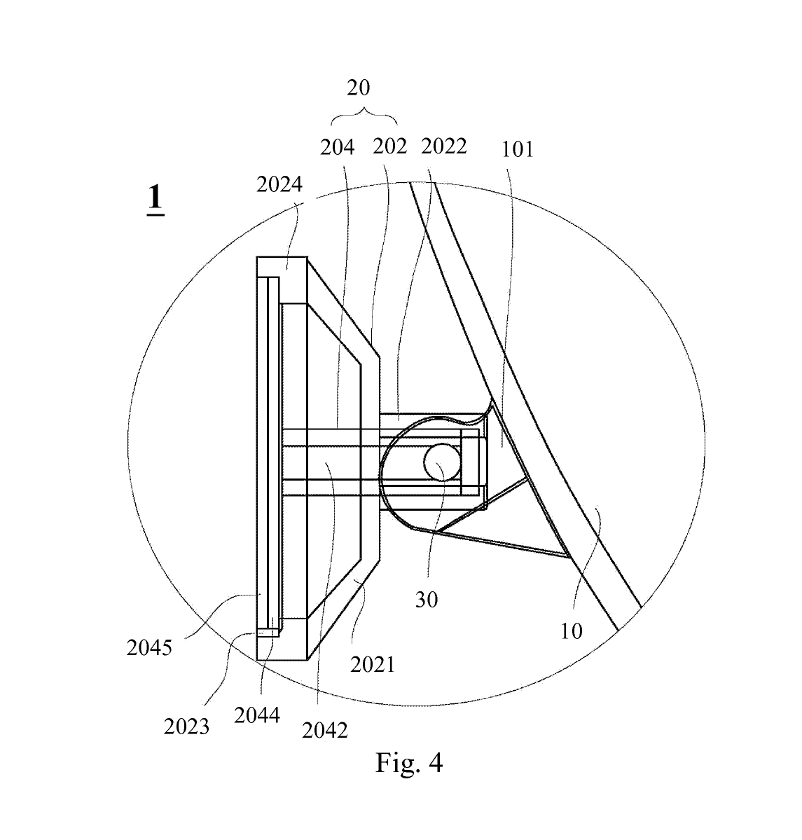

As shown in FIG. 3. In the first embodiment of the present invention, the shower nozzle device 1 includes a shower nozzle body 10 and a sucking disc 20. The sucking disc 20 includes a gland 202 and a pull rod 204. The shower nozzle device 1 is assembled by passing a bolt 30 at the same time through several holes, which are separately the holes 1011 on the pair of the protrusions 101, the first through hole 2026 on the hollow cylinder 2022 extended from the center of the gland 202 and the second through hole 2043 on the rod body 2042 extended from the center of the pull rod 204. In the present invention, the main technical characteristic is able to move the shower nozzle body 10 forwards and backwards so that the shower nozzle device 1 can be attached to the adsorbed surface 40 or detached from the adsorbed surface 40.

The purpose of using the shower nozzle body 10 and the basic principle of attaching the sucking disc 20 to the adsorbed surface 40 are understood by the person having ordinary knowledge in the art. Therefore, as far as the characteristic of combining the shower nozzle body 10 and the sucking disc 20 and the effectiveness produced are concerned it is illustrated in the following description of the present invention. In addition, the drawings in the following description are not drawn by the actual size, and the diagrams are only to show some characteristics relative to the present invention.

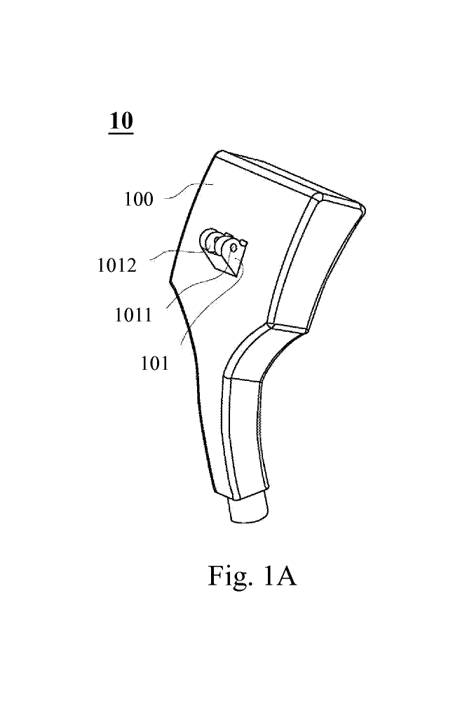

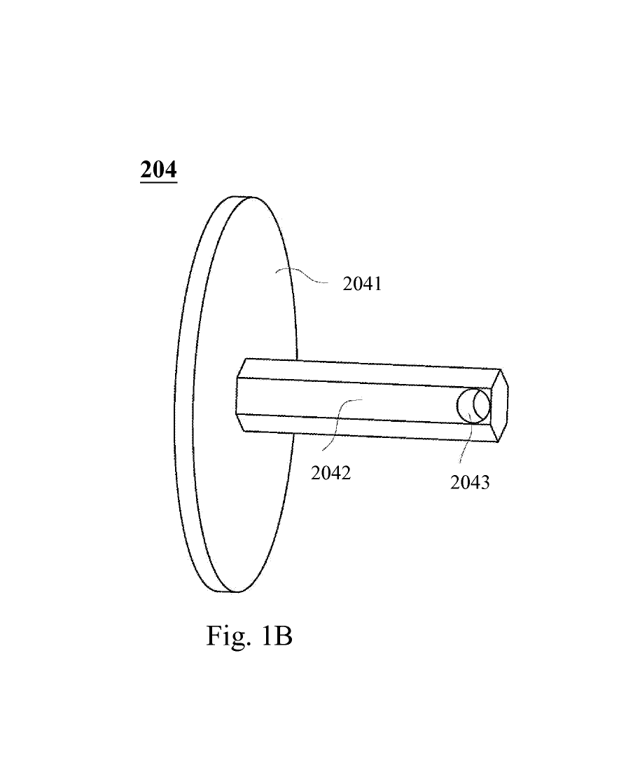

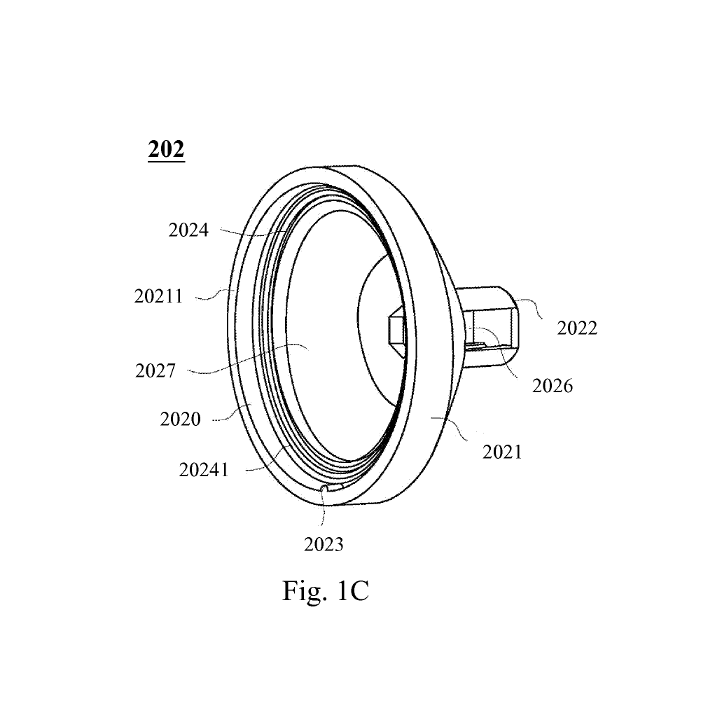

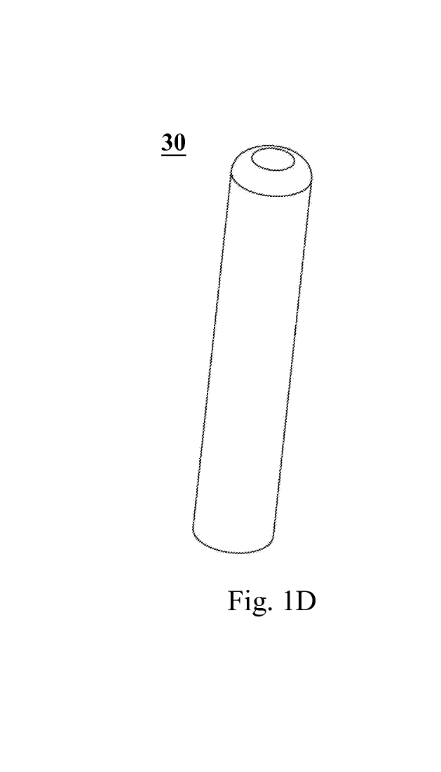

As shown in FIG. 1A to 1C, 2, 3, and 4. According to the first embodiment of the present invention, the shower nozzle device 1 includes a shower nozzle body 10 and a sucking disc 20. The shower nozzle body 10 includes a pair of the protrusions 101 disposed on a surface 100 reversely opposite to blowholes (not shown) and each protrusion. 101 includes a hole 1011. The sucking disc 20 includes a gland 202 and a pull rod 204, and the gland 202 includes a circular cover 2021 and a hollow cylinder 2022 extended from the center of the circular cover 2021. The hollow cylinder 2022 includes the first through hole 2026. The pull rod 204 includes a plane 2041 and a rod body 2042 extended from center of the plane 2041. The rod body 2042 includes a second through holes 2043. When the assembly of the gland 202 and the pull rod 204 is finished, the first through hole 2026 on the hollow cylinder 2022 of the gland 202 is aligned to the second through hole 2043 on the rod body 2042 of the pull rod 204. The hollow cylinder 2022 of the gland 202 is further disposed between the pair of the protrusions 101 of the shower nozzle body 10 so that the first through hole 2026 of the hollow cylinder 2022 is aligned to the hole 1011 of the pair of the protrusions 101. Thereafter, the shower nozzle device I is able to assembled by passing the bolt 30 at the same time through the hole 1011 on the pair of the protrusions 101 of the shower nozzle body 10, the first through hole 2026 on the hollow cylinder 2022 of the gland 202 and the second through hole 2043 on the rod body 2042 of the pull rod 204.

As shown in FIG. 1A to 1D and FIG. 3, the pair of the protrusions 101 on the backside of the shower nozzle body 10 is mainly used to assemble the sucking disc 20 and the bolt 30 together. The pair of the protrusions 101 is a concave-shaped structure producing a space 1012, by which two sides are separated. Each side has a hole 1011 that the bolt 30 can be passed through. The shower nozzle device 1 is assembled by putting the hollow cylinder 2022 and the rod body 2042 into the space 1012 of the concave-shape structure, then the bolt 30 is mutually passed through the first through hole 2026 on the hollow cylinder 2022, the second through hole 2043 on the rod body 2042 and the holes 1011 at two sides of the concave-shape structure. The bolt 30 is a strip-type cylinder to be the medium of the assembly to the shower nozzle body 10 and the sucking disc 20. Especially, as shown in FIG. 3 of the present embodiment, the radial distance from the top pair of the protrusions 101 outside to the hole 1011 is different. The radial distance from the top pair of the protrusions 101 outside to the hole 1011 is smaller than the radial distance from the bottom pair of the protrusions 101 outside to the hole 1011.

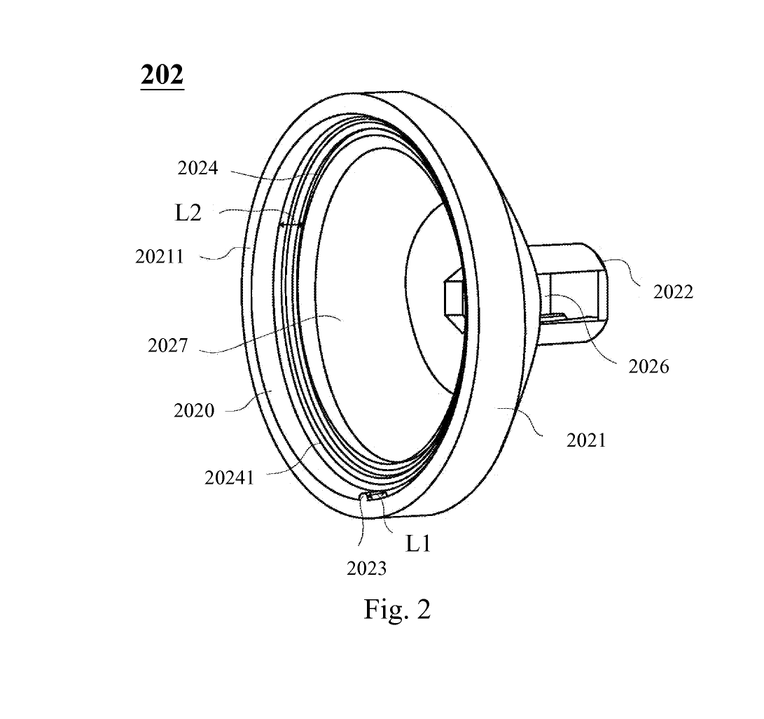

As shown in FIG. 2. The gland 202 of the sucking disc 20 includes the circular cover 2021 which the internal part is hollow to produce a space 2027, and the internal surface 2020 in the circular cover 2021 has a circular protrusion 2024. A protrusion 2023 disposed in the radial direction of the circular cover 2021 is located in the internal surface 2020 between an open end 20211 of the circular cover 2021 and an open end 20241 of the circular protrusion 2024. The protrusion 2023 is a semicircular cylindrical shape and has a thickness LI in the axial direction of the circular cover 2021. The purpose of disposing the protrusion 2023 is to separate the gland 202 and the pull rod 204 when the user would like to detach the sucking disc 20 from the adsorbed surface 40. The circular protrusion 2024 has a thickness L2 in the radial direction of the circular cover 2021. The thickness L2 is in action to cause the plane 2041 of the pull rod 204 to be against the open end 20241 of the circular protrusion 2024 when the gland 202 and the pull rod 204 are disposed together. In addition, as shown in FIG. 3, the plane 2041 of the pull rod 204 includes a first adsorptive board 2044 and a second adsorptive board 2045. The better configuration regarding to the rod body 2042 of the pull rod 204 or the hollow cylinder 2022 of the circular cover 2021 prefers to be a hexagonal cylinder. The front side of the rod body 2042 has a second through hole 2043 to pass the bolt 30 through so as to assemble the shower nozzle body 10, the gland 202, the pull rod 204 and the bolt 30 together. The back side of the rod body 2042 is connected to the first adsorptive board 2044 and the second adsorptive board 2045, and both discs have the same size and stacked each other. The second adsorptive board 2045 is used to be attached to the adsorbed surface 40 where the sucking disc 20 is disposed. The material of the second adsorptive board 2045 is softer than the first adsorptive board 2044 so as to be attached to the adsorbed surface 40 easier.

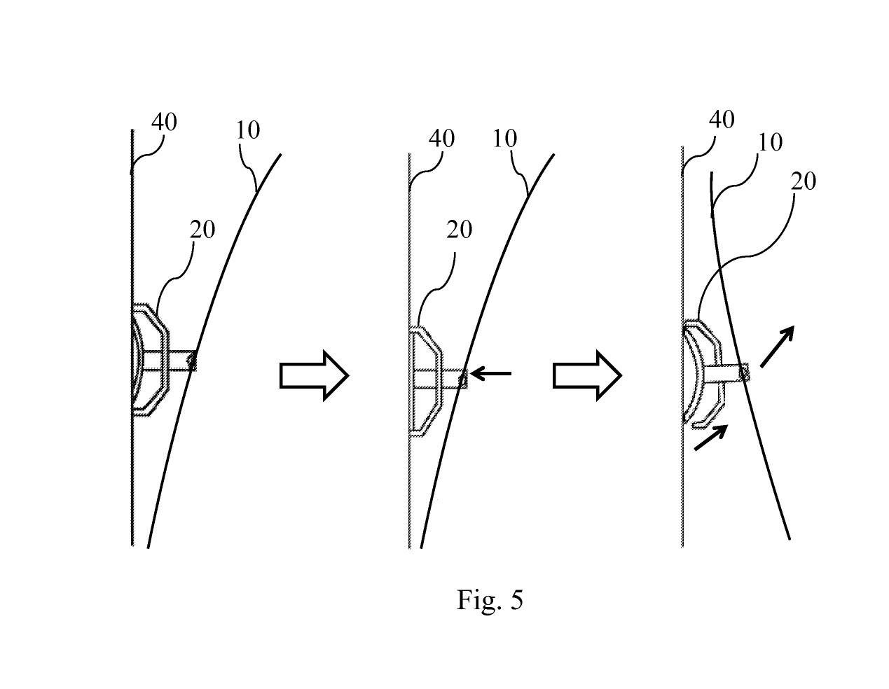

As shown in FIG. 5, according to the first embodiment of the present invention, it is a flow chart illustrating a using method of the shower nozzle device 1, and attaching a shower nozzle device 1 to the adsorbed surface 40 and detaching it from the adsorbed surface 40. First, approaching the sucking disc 20 to an adsorbed surface 40 and turning the shower nozzle body 10 to move backwards so that the second adsorptive board 2045 on the plane 2041 of the sucking disc 20 is able to be attached to the adsorbed surface 40; and then moving the shower nozzle body 10 forwards to turn the pair of the protrusions 101 and pressuring the pair of the protrusions 101 into the surface of the gland 202 by the gravity of the shower nozzle body 10.

Secondly, the shower nozzle body 10 is completely drooping and pressuring the pair of the protrusions 101 into the surface of the gland 202 by the gravity of the shower nozzle body 10. Based on the reason that the distance from the top pair of the protrusions 101 outside to the hole 1011 is smaller than the distance from the bottom pair of the protrusions 101 outside to the hole 1011, the rotation of the pair of the protrusions 101 can drive to move the pull rod 204 and the plane 2041 forwards by pressuring the gland 202. Therefore, the air between the second adsorptive board 2045 and the adsorbed surface 40 is excluded to enclose a vacuum and the first adsorptive board 2044 is firmly made against the open end 20241 of the circular protrusion 2024 to make the shower nozzle device 1 attached firmly to the adsorbed surface 40. Thirdly, for the purpose of detaching the shower nozzle device 1 from the adsorbed surface 40, turning the shower nozzle body 10 and moving the shower nozzle body 10 backwards to lift the shower nozzle body 10 to form a gap between the protrusion 2023 within the gland 202 and the plane 2041 of the pull rod 204. Thus, the vacuum is broken out when the air gets into the internal space 2027 of the gland 202, and that the distance from the top pair of the protrusions 101 outside to the hole 1011 is smaller than the distance from the bottom pair of the protrusions 101 outside to the hole, the rotation of the pair of the protrusions 101 releases the pressure from the pair of the protrusions 101 to the gland 202 so as to drive the gland 202 to move and to move the pull rod 204 and the plane 2041 backwards.

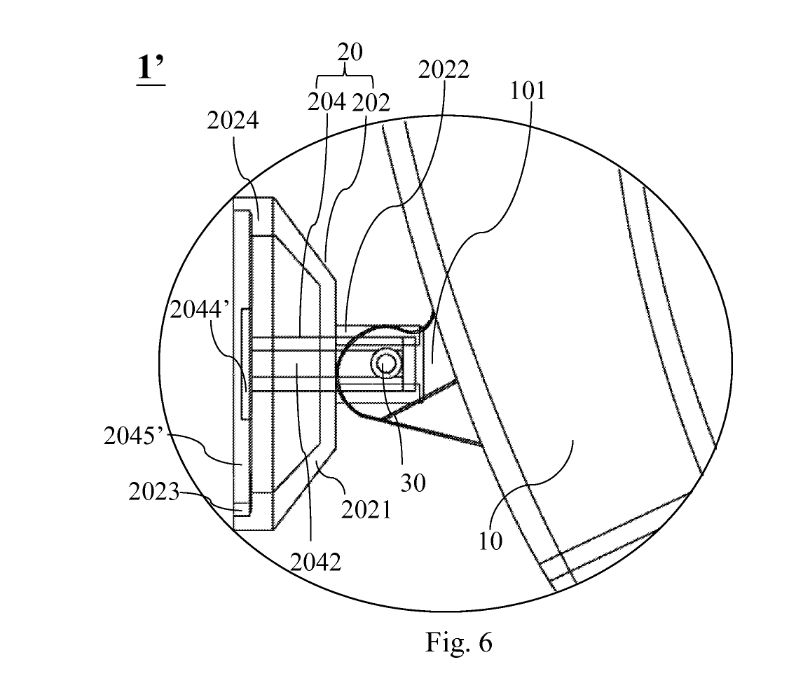

As shown in FIG. 6, according to the second embodiment of the present invention, it is a using method of the shower nozzle device 1′. The basic structure of the shower nozzle device 1′ in the second embodiment is the same as the first embodiment describing the shower nozzle device I composed of a shower nozzle body 10 and a sucking disc 20. The shower nozzle body 10 includes a pair of the protrusions 101 disposed on a surface 100 reversely opposite to blowholes (not shown) and each protrusion 101 includes a hole 1011. The sucking disc 20 includes a gland 202 and a pull rod 204, and the gland 202 includes a circular cover 2021 and a hollow cylinder 2022 extended from the center of the circular cover 2021. The hollow cylinder 2022 includes the first through hole 2026. The pull rod 204 includes a plane 2041 and a rod body 2042 extended from the center of the plane 2041. The rod body 2042 is a hexagonal cylinder and has a second through hole 2043 in the front side of the rod body 2042 for passing the bolt 30 through to assemble the shower nozzle body 10, the gland 202, the pull rod 204 and the bolt 30 together. The gland 202 of the sucking disc 20 has a circular protrusion 2024 in the internal surface 2020 of circular cover 2021. A protrusion 2023 disposed in the radial direction of the circular cover 2021 is located in the internal surface 2020 between an open end 20211 of the circular cover 2021 and an open end 20241 of the circular protrusion 2024. The difference of the present embodiment from the first embodiment is in the following of the description, the back side of the rod body 2042 is connected to the plane 2041, inclusive of the first adsorptive board 2044′ and the second adsorptive board 2045′. Both discs are different sizes and the area of the second adsorptive board 2045′ is larger than the first adsorptive board 2044′. The second adsorptive board 2045′ is used to be attached to the adsorbed surface 40 where the sucking disc 20 is disposed. The material of the second adsorptive board 2045′ is softer than the first adsorptive board 2044′ so as to be attached to the adsorbed surface 40 easier.

Preferred embodiments of the present invention have been described above. Those skilled in the art will understand, however, that changes and modifications may be made to these embodiments without departing from the true scope and spirit of the invention, which is defined by the claims.

What is claimed is:

1. A shower nozzle device, comprising:
a shower nozzle body including a pair of the protrusions disposed on a surface reversely opposite to blowholes and each protrusion has a concave-shape structure and a hole, a radial distance from one outer edge in each of the protrusions to the hole is smaller than the radial distance from another outer edge in each of the protrusions to the hole;
the sucking disc including a gland and a pull rod, the gland having a circular cover and a hollow cylinder extended from the center of the circular cover, the pull rod having a plane and a rod body extended from the center of the plane, the hollow cylinder including a first through hole and the rod body including a second through hole, the rod body disposed in the hollow cylinder and the hollow cylinder disposed between the pair of the protrusions, the first through hole on the hollow cylinder, the second through hole on the rod body and the holes on the pair of the protrusions are mutually aligned; and
a bolt passed through the first through hole of the hollow cylinder, the second through hole of the rod body and the holes of the pairs of the protrusions.

2. The shower nozzle device of claim 1, wherein an internal surface of the circular cover including a circular protrusion, and a protrusion disposed in the radial direction of the circular cover being located in the internal surface between an open end of the circular cover and an open end of the circular protrusion, the protrusion being a semicircular cylindrical shape and having a thickness L1 on the axial direction of the circular cover.

3. The shower nozzle device of claim 1, wherein the circular protrusion includes a thickness L2 on the radial direction of the circular cover.

4. The shower nozzle device of claim 1, wherein the plane includes a first adsorptive board and a second adsorptive board, and the second adsorptive board is softer than the first adsorptive board.

5. The shower nozzle device of claim 1, wherein the area of the second adsorptive board is larger than the first adsorptive board.

6. The shower nozzle device of claim 1, wherein the hollow cylinder and the rod body are hexagonal cylinder.
